(19) United States
(12) Patent Application Publication
(10) Pub. No.: US 2005/0044793 A1
(43) Pub. Date: Mar. 3, 2005

(54) Door with holding device

(76) Inventor: Michael Hormann, Oerlinghausen (DE)

Correspondence Address: DILWORTH & BARRESE, LLP, 333 EARLE OVINGTON BLVD., UNIONDALE, NY, 11553, US

(21) Appl. No.: 10/870,891

(22) Filed: Jun. 17, 2004

(30) Foreign Application Priority Data
Jun. 17, 2003 (DE) UM 203 09 354.2

(51) Int. Cl. E05D 15/38

(52) U.S. Cl. 49/197

(57) ABSTRACT

The invention concerns a door with a door panel that with the help of a slide rail mechanism can be moved between an open and a closed position. According to the invention, this door has at least one actuator with an engagement device that can be moved between an end position and a locking position, and which is positioned on an area of the door panel facing the slide rail mechanism of the door. In addition, there is a counter-device that is positioned permanently and with which the engagement device can be brought into contact in at least one intermediate position of the door panel between its open and its closed position in such manner that the door panel is fixed.

The invention concerns a door with a door panel that can be moved between an open and a closed position with the help of a slide rail mechanism.

Such doors exist in the form of, for example, overhead doors, swinging doors, rolling doors, or sectional doors. As a rule, doors of such type have mechanisms that facilitate their locking in closed position. Such locking devices are described as embodiments of sectional doors in DE 101 00 366 A1 and EP 0 073 964 B1, and facilitate the fixing of the door panel in closed position.

The task of the within invention is to provide a door that permits greater flexibility.

This task is performed with a door having the characteristics of claim 1 or a door having the characteristics of claim 6.

According to the invention, there is at least one actuator, which is equipped with a movable engagement device and which can work together with a counter-device to fix the door panel in an intermediate position between open and closed position. In the embodiment according to claim 1, the actuator is positioned on an area of the door panel that faces the slide rail mechanism, and moves together with the door panel. The counter-device is positioned permanently, preferably on or in the door frame. In the alternative embodiment of claim 6, the actuator is positioned permanently, preferably on or in the door frame, and the counter-device is on the door panel and moves together with the door panel.

In the following description, as a general rule, embodiments are described in which the door panel moves vertically between open and closed position. Analogously, the invention can also be used on doors in which the door panel moves horizontally between open and closed position.

The door according to the invention allows the door panel to be secured in a variety of positions by means of mechanical engagement of the engagement device with the counter-device.

With doors according to the invention, it is possible to fix the door panel in an intermediate position between open and closed position. In this position, the door panel can be secured so that movement is impossible. A malfunction of the motor moving the door panel or, for example, a malfunction of the drive or traction cable between the drive device and the door panel does not lead to an uncontrolled movement of the door. Also, an undesired manual movement is not possible without prior activation of the actuator. The door according to the invention is thus very flexible and nevertheless very secure. Particularly in the case of large doors, e.g. industrial doors, it is not always necessary to position the door in complete open position. For example, in the case of doors that are several meters tall, it is often enough if the door is positioned in such position as to create a two-meter-tall opening sufficient to admit, for example, a truck.

It is particularly advantageous if an intermediate position between open and closed position can be selected in which the door panel is fixed just a few centimeters from closed position. In this way a ventilation position can be created for the space closed off by the door. In the case of doors that move vertically, an opening a few centimeters high can thereby be created between the door panel and the ground.

In a special embodiment, an additional engagement position is provided in which the engagement device and the counter-device can be positioned in the closed position of door panel 1. In this way the actuator according to the invention and the counter-device according to the invention are used, not only to fasten the door panel in an intermediate position, but also to lock the door in closed position. A separate locking device for closed position is then no longer needed.

The engagement device and the counter-device can be designed in various ways. For example, provision can be made for pre-stressing of the engagement device against or in the counter-device by means of the actuator, to prevent movement of the door panel. Such an arrangement facilitates, for example, the desired choice of intermediate position. For low cost and precise operation, however, it is particularly appropriate if the counter-device has one or more recesses in which a slide-like engagement device can engage. In this way, pre-determined positions of the door panel can be made reproducible. For example, one suitable engagement device is a slide that can be moved by the actuator and which can engage in one or more holes in the counter-device, which said holes are positioned in such manner that upon engagement a position of the door panel between open and closed position is fixed. In a further development of the door according to claim 1, the counter-device can have, for example, a rail with recesses, e.g. a perforated rail that is attached to the door frame or which is formed by the door frame itself. Similarly, a slide rail in which a runner of the door panel runs can be designed as a counter-device, if an appropriate arrangement of holes is provided therein.

In an appropriate further development of a door according to claim 6, in which the actuator is designed to be permanently fixed and the counter-device moves with the door panel, the counter-device can similarly take the form of a series of holes in, for example, the front of the door panel facing the frame.

Particularly in embodiments in which several recesses for the engagement device are provided so that several intermediate positions for the door panel can be created, in a further development of a door according to claim 1 it is advantageous if in the case of a door that moves vertically the actuator is positioned in the lower portion of the door panel, so that intermediate positions in as large a range of the door panel movement as possible can be created. In the case of door panels that move horizontally, the actuator/counter-device arrangement can be chosen in similar manner, to facilitate intermediate positions in as large a range of the door panel movement as possible.

In an actuator with a slide as engagement device, the slide can be moved in various ways. Design as an electromagnetic or pneumatic hoisting jack is particularly simple and low in cost.

In a particularly advantageous design, the actuator can be controlled by, for example, an infra-red segment, or via radio.

The invention can be applied in various types of doors. However, use in rolling doors or sectional doors is particularly advantageous, since in these types the arrangement of actuator and counter-device is particularly simple.

The invention is explained in detail by means of the following figures, which show:

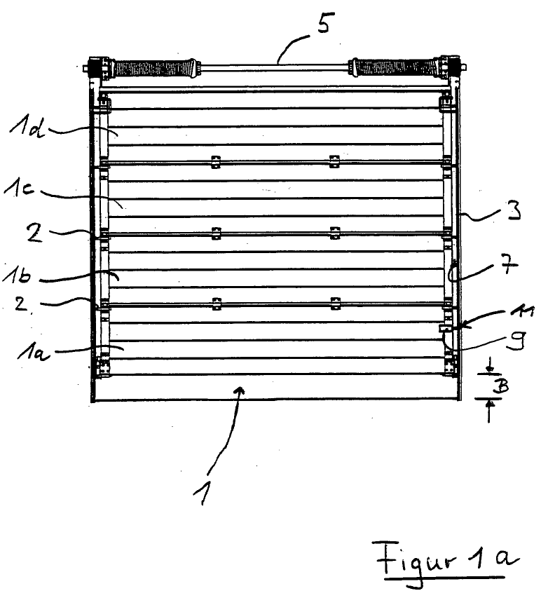

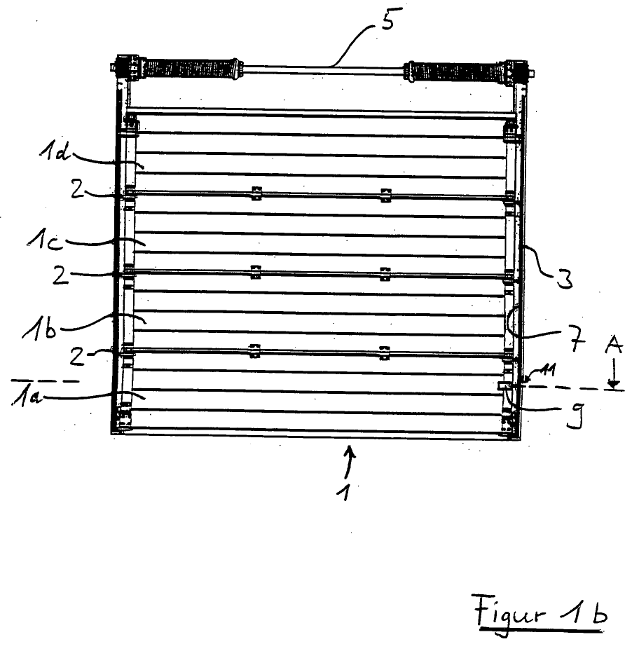

FIG. 1: Detail of the actuator area in one embodiment of a door according to the invention,

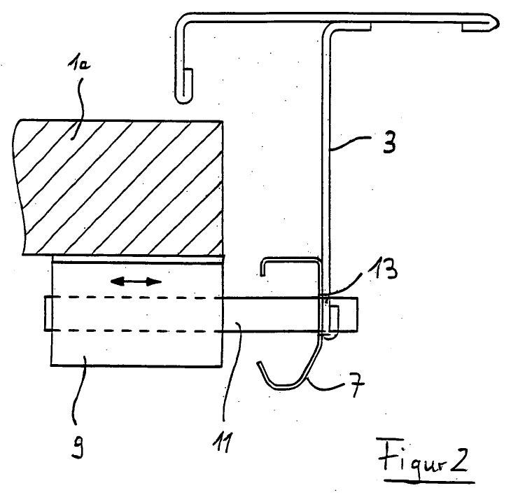

FIG. 2: A top view of one embodiment of a door according to the invention, in closed position, with an actuator of the type in FIG. 1,

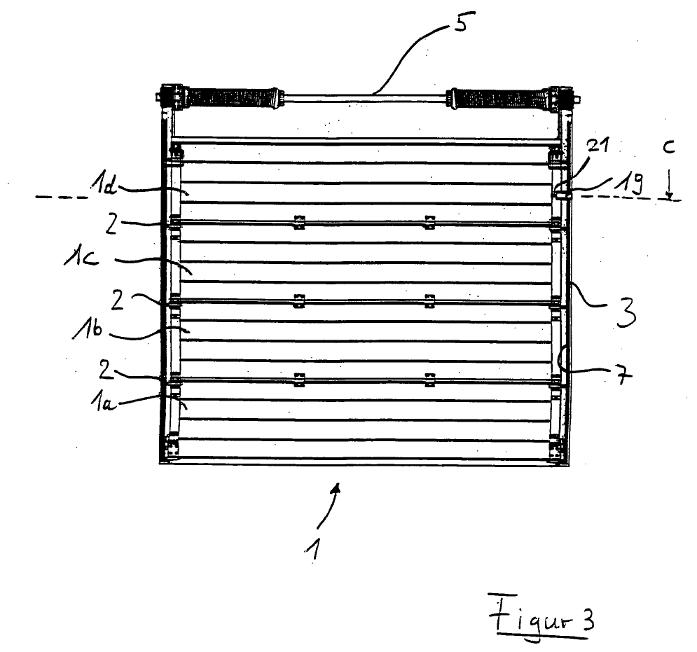

FIG. 3: A schematic detail of the actuator area in another embodiment of a door according to the invention, and

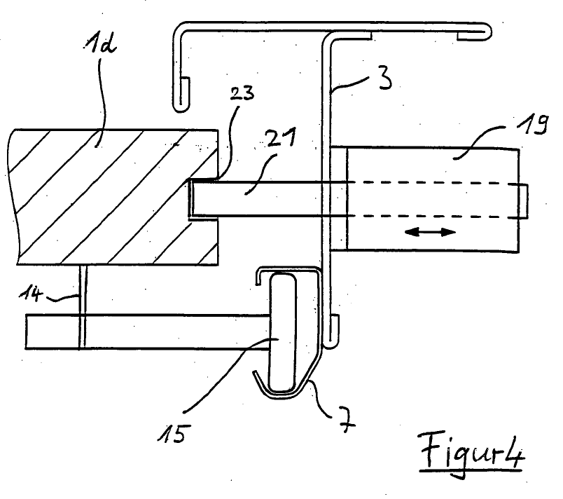

FIG. 4: A top view of a door of this embodiment according to the invention, in closed position.

FIG. 2 shows an example of a sectional door designed according to the invention. A sectional door has in known manner a door panel 1 that consists of individual panels 1a, 1b, 1c, and 1d, which are movably jointed to one another in articulation areas 2. In articulation area 2 there are track wheels that engage with a slide rail 7 attached to frame 3. When door panel 1 is drawn upward with the help of a motor-driven shaft 5, these track wheels run in rail 7 and in this way guide the door panel, for example from a closed position, as shown in FIG. 2, to an open position.

The door according to the invention has an actuator 9, which is explained in detail with reference to FIG. 1. The sectional door illustrated has, for example, four door panels 1a, 1b, 1c, and 1d. FIG. 1 shows an illustration along a section indicated in FIG. 2 as A. Frame 3 with its attached slide rail 7 is visible. Actuator 9 has a slide 11 that can be moved by means of, for example, an electromagnetic mechanism in the direction indicated by the arrows. Actuator 9 is attached to door panel 1a. In the embodiment illustrated, there is a row of holes along rail 7, which has holes 13 that extend through rail 7 and frame 3. Along slide rail 13 there are several openings 13 arranged vertically. The openings are not visible in the top view in FIG. 2. Slide 11, which fits through an opening 13 in slide rail 7 or frame 3, is shown in FIG. 2. With the help of actuator 9, slide 11 can be introduced into these holes and in this way the door panel can be fixed in a position. Holes 13 are arranged along rail 7 or frame 3 in such manner that the door panel can in this way be fixed at various-positions between open and closed positions. In particular, an opening 13 is provided in such manner that the door panel can be fixed in a position such as to leave a gap of only a few centimeters, to facilitate ventilation of the space that can be closed off by the door.

Lastly, in the embodiment illustrated in FIG. 2; there is also a hole 13, which can be made to engage with slide 11 only if the door panel is in closed position. In this way the embodiment according to the invention can not only fix the door panel in intermediate positions between open and closed position, but can also lock the door panel in closed position.

Actuator 9, shown only schematically, is designed to be remote-controlled. Appropriately, an existing remote control for door operation is modified in such manner that it can also be used for the actuator.

FIG. 3 shows a detail of another embodiment. It shows a cross-sectional view in viewing direction B, as indicated in FIG. 4 for this embodiment. FIG. 4 shows a top view of the door according to this embodiment, in closed position. In the top view of FIG. 4, openings 23 in the fronts of door panels 1a, 1b, 1c, and 1d facing frame 3 are not visible. However, slide 21 of actuator 19 is recognizable.

In the embodiment according to FIG. 3, electromagnetic actuator 19 is permanently connected with frame 3. Mobile slide 21, which can fit into recesses 23 at various heights in door panel 1, extends through frame 3. Visible in FIG. 3 is a recess 23 in panel 1d.

FIG. 3 illustrates schematically the fact that the axis of slide roller 15 is connected, via a schematically illustrated holding device 14, with the door panel.

In the front of door panel 1 facing frame 3, there are recesses 23 at various heights, so that slide 21 can engage with appropriate recesses 23 when the door panel is to be fixed at various heights. Actuator 19 is positioned in the upper area of the door frame, so that the largest possible area of door panel setting positions at various heights can be created.

An additional recess is positioned in such manner that the engagement of this recess and slide 21 in a position of door panel 1 that corresponds to the closed position of the door is possible.

In the embodiments in FIGS. 3 and 4 as well, the actuator is shown in remote-control manner in the same manner as in reference to FIG. 1 or 2.

The door according to the invention in FIGS. 1 or 2 can be used as follows. In the closed position in FIG. 2, slide 11 of actuator 9 engages with the lowest hole 13 in slide rail 7 or frame 3. For example, with the help of remote control, electromagnetic actuator 9 is activated in such manner that slide 11 is drawn out of hole 13. A known sectional-door drive moves rotary shaft 5 so that door panel 1 is drawn upward. To achieve a ventilation position, another opening 13 is provided a few centimeters above the lowest opening 13. Door panel 1 of sectional door can be held in this position and for example with the help of a remote control of actuator 9 can be activated in such manner that slide 11 moves into this second opening 13. In this way the door panel is fixed in ventilation position. In similar manner, the door panel can be fixed in several different positions by means of appropriately positioned openings 13. For example, an opening 13 can be provided at a height such that the door panel creates an opening large enough to admit a truck, without any need to fix the door in fully-open position.

The embodiment of FIGS. 3 and 4 can be used in similar manner. In closed position, shown in FIG. 4, slide 21 of actuator 19 engages in a recess 23 in the front of door panel 1d. Actuator 19 is activated by means of, for example, a remote control, so that slide 21 is drawn out of opening 23, facilitating release of door panel 1. If the sectional door is then drawn upward in known manner via operating rotary shaft 5, there is nothing to prevent this movement of the engagement between slide 21 and opening 23. Several centimeters below opening 23 in door panel 1d, there is another opening in the front of door panel 1. If slide 21 is made to engage with this second opening, the door panel is fixed in a position such as to create an opening several centimeters wide and thereby establish a ventilation position. Along the front of door panel 1 there are several openings 23, including for example an opening that allows the door panel to be fixed at a height that allows for the passage of a truck.

Needless to say, in all embodiments according to the invention, provision can be made for automatic movement of the door panel into a position in which engagement of slide 11, 21 with an opening 13, 23 is possible.

The door according to the invention can thus be fixed and secured in various positions between open and closed position.

In a sectional door or a rolling door, both the embodiments of FIGS. 1 and 2 and the embodiments of FIGS. 3 and 4 are possible. In particular, the embodiment of FIGS. 1 and 2 are also suitable for use in a swinging door or an overhead door, with appropriate positioning of openings 13 in, for example, the slide rail, and of the actuator.

1. Door with a door panel that with the help of a slide rail mechanism can be moved between an open and a closed position,
characterized by
At least one actuator (9) with an engagement device (11) that can be moved between an end position and a locking position, and which is positioned on an area of the door panel facing the slide rail mechanism, and
A counter-device (3, 7) that is positioned permanently, preferably on or in the door frame, and with which the engagement device (11) can be brought to engage in at least one intermediate position of the door panel (1) between its open and its closed position in such manner that the door panel (1) is fixed.

2. Door according to claim 1, characterized by the fact that
The engagement device (11) has a slide (11) that can be moved by the actuator (9) from the door panel (1) in the direction of the counter-device (3, 7), and
The counter-device (3, 7) has at least one recess (13) positioned in such manner that the door panel (1) is in an intermediate position between open and closed position when the slide (11) can engage with the recess (13).

3. Door according to claim 2, characterized by the fact that the counter-device has an arrangement of several recesses (13) positioned essentially along the slide rail arrangement.

4. Door according to claim 1, characterized by the fact that the counter-device is part of the slide rail mechanism (7) and/or the frame (3) of the door.

5. Door according to one claim 1, characterized by the fact that the actuator (9) is positioned in that area of the door panel (1) that moves out ahead when the panel moves to close.

6. Door with a door panel that with the help of a slide rail mechanism can be moved between an open and a closed position,
characterized by
At least one actuator (19) with an engagement device (21) that can be moved between an end position and a locking position, and which is positioned permanently, preferably on or in the door frame, and
A counter-device that is positioned on the door panel (1), and which can be brought to engage with the engagement device (21) in at least one intermediate position of the door panel (1) between its open and its closed position in such manner that the door panel (1) is fixed.

7. Door according to claim 6, characterized by the fact that
The engagement device (21) has a slide (21) that can be moved by the actuator (19) toward the counter-device, and
The counter-device has at least one recess (23) positioned on or in the door panel (1) in such manner that the door panel (1) is in an intermediate position between its open and its closed position when the slide (21) can engage with the recess (23).

8. Door according to claim 7, characterized by the fact that the counter-device has a series of recesses (23) along the door panel (1) edge facing the actuator (19).

9. Door according to claim 6, characterized by the fact that the counter-device is an integral component of the door panel (1).

10. Door according to claim 6, characterized by the fact that the actuator (19) is positioned in that area of the door frame (3) closest to the door panel (1) area that trails when the door panel (1) is opening.

11. Door according to claim 1, characterized by the facts that the engagement device (11, 21) can be made to engage with the counter-device in a position of the door panel (1), that the door panel (1) is fixed in a ventilation position in which the door panel (1) is a few centimeters from the closed position.

12. Door according to claim 1, characterized by the fact that the engagement device (11, 21) can be made to engage with the counter-device in a door panel (1) position that corresponds to the closed position of the door panel (1).

13. Door according to claim 1, characterized by the fact that the actuator (9, 19) has a pneumatic hoist jack.

14. Door according to claim 1, characterized by the fact that the actuator (9, 19) has an electromagnetic hoist jack.

15. Door according to claim 1, characterized by the fact that the actuator (9, 19) is remote-controlled.

16. Door according to claim 1, characterized by the fact that the door is a sectional or rolling door.

17. Door according to claim 2, characterized by the fact that the counter-device is part of the slide rail mechanism (7) and/or the frame (3) of the door.

18. Door according to claim 3, characterized by the fact that the counter-device is part of the slide rail mechanism (7) and/or the frame (3) of the door.

19. Door according to claim 2, characterized by the fact that the actuator (9) is positioned in that area of the door panel (1) that moves out ahead when the panel moves to close.

20. Door according to claim 3, characterized by the fact that the actuator (9) is positioned in that area of the door panel (1) that moves out ahead when the panel moves to close.
